(19) United States
(12) Patent Application Publication
(10) Pub. No.: US 2021/0209410 A1
(43) Pub. Date: Jul. 8, 2021

(54) METHOD AND APPARATUS FOR CLASSIFICATION OF WAFER DEFECT PATTERNS AS WELL AS STORAGE MEDIUM AND ELECTRONIC DEVICE

(71) Applicant: Changxin Memory Technologies, Inc., Hefei (CN)

(72) Inventor: Xiaodong PAN, Hefei (CN)

(21) Appl. No.: 17/206,884

(22) Filed: Mar. 19, 2021

Related U.S. Application Data
(63) Continuation of application No. PCT/CN2019/107051, filed on Sep. 20, 2019.

(30) Foreign Application Priority Data
Sep. 21, 2018 (CN) 201811109704.7

(51) Int. Cl. G06K 9/62; G01N 21/95; G01N 21/956

(52) U.S. Cl. CPC G06K 9/6218; G06K 9/6267; G06K 9/6259; G01N 21/956; G01N 21/9501

(57) ABSTRACT

This disclosure relates to a method for classification of wafer defect patterns, and an apparatus, a storage medium, and an electronic device thereof. The method may include obtaining wafer images with labeled defect positions, obtaining a trained convolutional neural network (CNN) and a trained auto-encoder, obtaining feature data of the wafer images by extracting features from the wafer images with the trained CNN, generating feature codes of the wafer images by encoding the feature data of the wafer images with the trained auto-encoder, and clustering feature codes of a plurality of wafer images with labelled defect positions, and performing defect pattern classification on the respective wafer images based on a result of the clustering. Accordingly, amount and cost of labor can be greatly reduced, classification efficiency and accuracy can be significantly increased, and ability of processing massive data can be archived by directly coupling to an EDA system.

### CROSS-REFERENCE TO RELATED APPLICATIONS

This application is a continuation application of International Patent Application No. PCT/CN2019/107051, filed on Sep. 20, 2019, which is based on and claims priority to and benefits of the Chinese Patent Application No. 201811109704.7, filed with the State Intellectual Property Office (SIPO) of the People's Republic of China on Sep. 21, 2018. The entire contents of the above-referenced applications are incorporated herein by reference.

### TECHNICAL FIELD

This disclosure relates to computer technology, in particular, to a method for classification of wafer defect patterns, and an apparatus, a storage medium, and an electronic device thereof.

### BACKGROUND

During fabrication of semiconductor devices, every die on wafers undergoes a series of tests to find out whether they are good or bad (i.e., whether they can pass the tests), and the test results of the dies can be used to determine whether the wafers satisfy defined criteria. Wafers failing in meeting such criteria often have defects following certain patterns, which usually reflect problems in design and production processes. Therefore, for the fabrication of semiconductor devices, it is important to classify patterns of defects in scrapped wafers.

Currently, defects patterns in scrapped wafers are usually manually labeled and classified based on the labeling results. Based on the classification of the defect patterns, the cause of each defect pattern can be determined. Solutions for preventing the various defect patterns can be found based on the respective causes, thereby improving the production yield of the next wafer lot.

Obviously, in the above approach, the method of manually labeling and classifying the defect patterns requires intensive manual labor, which leads to a high labor cost and a low efficiency and may inevitably introduce human errors. For example, labeling errors may lead to incorrect classification, resulting in a low classification accuracy.

It is to be noted that the above information disclosed in this Background section is only for enhancement of understanding of the background of the invention. Therefore, information contained in this section does not form the prior art that is already known to a person of ordinary skill in the art.

### SUMMARY OF THE INVENTION

The present disclosure presents a method for classification of a wafer defect pattern, and an apparatus, a storage medium, and an electronic device thereof, which can solve the problems arising from manually labeling and classifying, such as intensive manual labor, a high labor cost, a low efficiency, and a low accuracy.

One aspect of the present disclosure is directed to a method for classification of wafer defect patterns. The method may comprise: obtaining a trained convolutional neural network (CNN) and a trained auto-encoder; acquiring a wafer image with at least a labelled defect position; obtaining a feature datum of the wafer image by extracting a feature from the wafer image with the trained CNN; generating a feature code of the wafer image by encoding the feature datum of the wafer image with the trained auto-encoder; and clustering feature codes of a plurality of wafer images and performing the defect pattern classification on the respective wafer images based on a result of the clustering.

In one embodiment of the present disclosure, the obtaining the feature datum of the wafer image by extracting the feature from the wafer image with the trained CNN may comprise: obtaining a first feature datum by extracting the feature from the wafer image with at least one first convolution kernel; obtaining a second feature datum by extracting a feature from the first feature datum with at least one second convolution kernel; obtaining a third feature datum by performing a first pooling process on the second feature datum; obtaining a fourth feature datum by extracting a feature from the third feature datum with at least one third convolution kernel; obtaining a fifth feature datum by extracting a feature from the fourth feature datum with at least one fourth convolution kernel; and obtaining the feature datum of the wafer image by performing a second pooling process on the fifth feature datum.

In one embodiment of the present disclosure, the method may further comprise: obtaining an initial CNN and an initial auto-encoder; obtaining a plurality of samples of the wafer image labeled with a defect position; obtaining feature data of the respective samples of the wafer image by extracting features from the respective samples of the wafer image with the initial CNN; obtaining feature codes of the respective samples of the wafer image by encoding the feature data of the respective samples of the wafer image with the initial auto-encoder; obtaining decoded data of the respective samples of the wafer image by decoding the feature codes of the respective samples of the wafer image with the initial auto-encoder; and calculating a difference between a sample of the wafer image and the decoded data of a corresponding sample of the wafer image to adjust a parameter of the initial CNN and a parameter of the initial auto-encoder to obtain the trained CNN and the trained auto-encoder.

In one embodiment of the present disclosure, the calculating the difference between the sample of the wafer image and the decoded data of the corresponding sample of the wafer image may comprise: calculating the difference between the sample of the wafer image and the decoded data of the corresponding sample of the wafer image based on pixel values in the samples of the wafer image and corresponding dimension values in the decoded data of the samples of the wafer image.

In one embodiment of the present disclosure, the clustering the feature codes of the plurality of wafer images and performing the defect pattern classification on the respective wafer images based on the result of the clustering may comprise: obtaining at least one feature class by clustering the feature codes of the plurality of wafer images; and performing the defect pattern classification on the respective wafer images based on the at least one feature class, wherein each feature class corresponds to a respective one of defect patterns.

In one embodiment of the present disclosure, the clustering the feature codes of the plurality of wafer images may comprise: clustering the feature codes of the plurality of wafer images by using an affinity propagation algorithm.

In one embodiment of the present disclosure, the defect pattern may include one or more of an edge arche-like defect pattern, a ring-like defect pattern, and a strip-like defect pattern.

In one embodiment of the present disclosure, the trained CNN may include convolutional layers and pooling layers. Each of the convolutional layers may be followed by one of the pooling layers.

In one embodiment of the present disclosure, the convolutional layers may be paired, and each pair of the convolutional layers may be followed by one of the pooling layers.

In one embodiment of the present disclosure, the trained auto-encoder may comprise at least one encoding layer, each of the at least one encoding layer having a plurality of neurons, and at least one decoding layer, each of the at least one decoding layer having a plurality of neurons.

In one embodiment of the present disclosure, the wafer image may be acquired by an engineering data analysis (EDA) system.

Another aspect of the present disclosure is directed to an apparatus for classification of wafer defect patterns. The apparatus may comprise: an acquisition module, configured to obtain a wafer image labeling a defect position; a convolution module, configured to obtain a trained convolutional neural network (CNN) and obtain a feature datum of the wafer image by extracting a feature from the wafer image with the trained CNN; an encoding module, configured to obtain a trained auto-encoder and generate a feature code of the wafer image by encoding the feature datum of the wafer image with the trained auto-encoder; and a classification module, configured to cluster the feature codes of a plurality of wafer images and perform the defect pattern classification on the respective wafer images based on a result of the clustering.

Another aspect of the present disclosure is directed to a non-transitory computer-readable storage medium storing a computer program. When the computer program is executed by a processor, it may cause the processor to execute the method as defined in any one of the foregoing embodiments.

Another aspect of the present is directed to an electronic device. The electronic device may comprise: a processor; and a memory device for storing instructions executable by the processor. The processor may be configured to execute the executable instruction to cause the processor to execute the method as defined in any one of the foregoing embodiments.

In embodiments of the present disclosure, a method and an apparatus for classification of wafer defect patterns, as well as a storage medium and an electronic device are provided. A CNN may be used to extract feature data from wafer images with labeled defect positions, and an auto-encoder may generate feature codes of the wafer images by encoding the feature data thereof. The feature codes of the plurality of wafer images may be clustered, and defect pattern classification may be performed on the plurality of wafer images based on a result of the clustering. In this way, an automatic defect pattern classification on wafer images may be achieved by a combination of the CNN, automatic encoding, and clustering techniques. This can significantly reduce the amount and cost of manual labor and enhance classification efficiency, when compared to the conventional manual classification methods. In addition, since manual classification is eliminated, human errors can be avoided, thus allowing a much higher classification accuracy. Moreover, due to the automatic classification, the method is suitable for use with an EDA system, which can be more powerful in processing massive data. Furthermore, compared to a supervised classification approach using merely a CNN for classification and requiring more time for feature extraction, the combination of a CNN, automatic encoding, and clustering is an unsupervised classification that can output classification results simply by inputting wafer images with labeled defect positions, without consuming considerable amount of time in feature acquisition. As a result, the time required by the entire classification process can be remarkably shortened, resulting in an improved classification efficiency.

It is to be understood that both the foregoing summary and the following detailed description are exemplary and explanatory only and are not restrictive to this disclosure.

### BRIEF DESCRIPTION OF THE DRAWINGS

The accompanying drawings, which are incorporated in and constitute a part of the description, illustrate embodiments of the present disclosure and, together with the description, serve to explain the disclosed principles. Apparently, these drawings present only some embodiments of the present disclosure. Those ordinary skill in the art may obtain drawings of other embodiments from the accompanying drawings without any creative effort.

FIG. 1 is a flowchart of a method for classification of wafer defect patterns, according to an embodiment of the present disclosure.

FIG. 2 shows a first wafer image with labeled defect positions, according to an embodiment of the present disclosure.

FIG. 3 shows a second wafer image with labeled defect positions, according to an embodiment of the present disclosure.

FIG. 4 shows a third wafer image with labeled defect positions, according to an embodiment of the present disclosure.

FIG. 5 shows a fourth wafer image with labeled defect positions, according to an embodiment of the present disclosure.

FIG. 6 shows a fifth wafer image with labeled defect positions, according to an embodiment of the present disclosure.

FIG. 7 shows a sixth wafer image with labeled defect positions, according to an embodiment of the present disclosure.

FIG. 8 shows a seventh wafer image with labeled defect positions, according to an embodiment of the present disclosure.

FIG. 9 shows an eighth wafer image with labeled defect positions, according to an embodiment of the present disclosure.

FIG. 10 is a flowchart of a process to obtain feature data of wafer images by extracting features therefrom with a CNN, according to an embodiment of the present disclosure.

FIG. 11 schematically illustrates edge arch-like defects, according to an embodiment of the present disclosure.

FIG. 12 schematically illustrates ring-like defects, according to an embodiment of the present disclosure.

FIG. 13 schematically illustrates strip-like defects, according to an embodiment of the present disclosure.

FIG. 14 is a flowchart of a process to train a CNN and an auto-encoder, according to an embodiment of the present disclosure.

FIG. 15 is a block diagram of an apparatus for classification of wafer defect patterns, according to an embodiment of the present disclosure.

FIG. 16 schematically illustrates modules in an electronic device, according to an embodiment of the present disclosure.

FIG. 17 is a schematic illustration of a program production, according to an embodiment of the present disclosure.

### DETAILED DESCRIPTION

Exemplary embodiments will now be fully described with reference to the accompanying drawings. However, these embodiments can be implemented in many forms and should not be construed as limitations to those set forth herein. Rather, these embodiments are presented to provide a full and thorough understanding of the present disclosure and to fully convey the concepts of the embodiments of the present disclosure to those skilled in the art. Throughout the figures, like reference numerals indicate identical or similar elements, thus descriptions thereof will not be duplicated.

In addition, the described features, structures, and characteristics may be combined in any suitable manner in one or more embodiments. In the following detailed description, many specific details are set forth to provide a more thorough understanding of the present disclosure. However, those skilled in the art will recognize that the various embodiments can be practiced without one or more of the specific details or with other methods, components, materials, or the like. In some instances, well-known structures, materials, or operations are not shown or not described in detail to avoid obscuring aspects of the embodiments of the present disclosure.

The represented blocks in the figures are purely functional entities, which do not necessarily correspond to physically separated entities. In other words, these functional entities may be implemented in software, or entirely or in part in one or more software-hardware modules, or in different networks and/or processor devices and/or microcontroller devices.

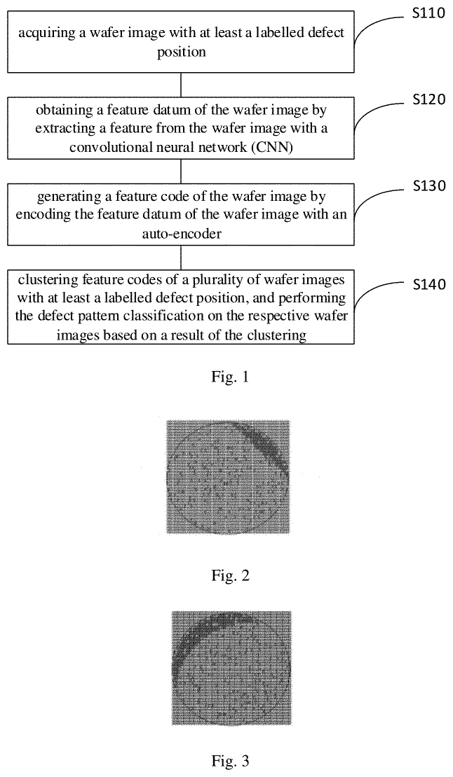

In one embodiment of the present disclosure, a method for classification of a wafer defect pattern is disclosed. As shown in FIG. 1, the method may include the following steps.

In step S110, wafer images with labelled defect positions may be obtained.

In step S120, feature data of the wafer images may be obtained by extracting features from the wafer images with a convolutional neural network (CNN).

In step S130, feature codes of the wafer images may be generated by encoding the feature data of the wafer images with an auto-encoder.

In step S140, the feature codes of the plurality of wafer images may be clustered and the defect pattern classification on the respective wafer images may be performed based on a result of the clustering.

This method for classification of a wafer defect pattern can automatically conduct defect pattern classification on wafer images by a combination of CNN, automatic encoding, and clustering techniques. Compared with the conventional manual classification methods, this method can significantly reduce the amount and cost of labor and enhance classification efficiency. In addition, the classification accuracy is improved significantly, the human errors can be avoided. Moreover, due to the automatic classification, the method is suitable for use with an engineering data analysis (EDA) system, and may be more powerful in processing massive data. Furthermore, since a supervised classification approach merely uses CNN for classification, it requires more time for feature extraction. However, the combination of a CNN, automatic encoding, and clustering is an unsupervised classification that can output classification results simply by inputting wafer images with labelled defect positions, without consuming considerable amount of time in feature acquisition. As a result, the time required by the entire classification process can be remarkably shortened to improve the classification efficiency.

The method for classification of a wafer defect pattern will be described in details below with reference to FIG. 1.

In step S110, acquiring wafer images with labelled defect positions.

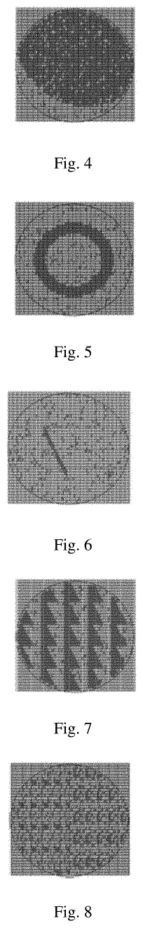

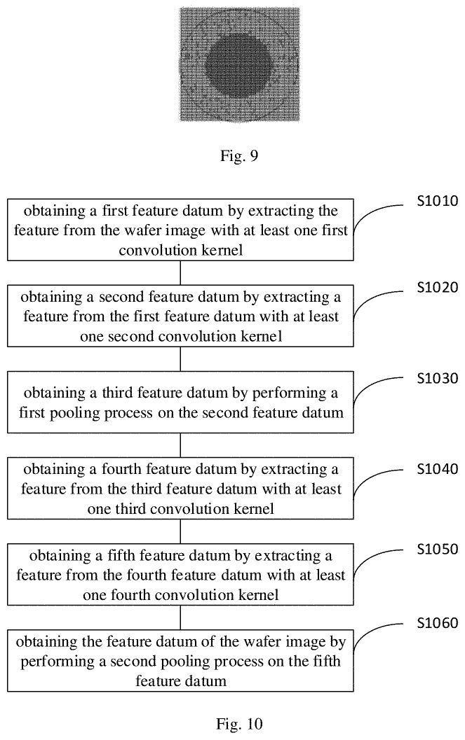

According to this embodiment of the present disclosure, the wafer images may be obtained either from an engineering data analysis (EDA) system or from an acquisition module. The wafer comprises a plurality of dies. After the wafer is fabricated, the dies formed on the wafers may be tested, and those dies fail to pass the tests (i.e., defective ones) may be labeled with ink. Herein, the defect position refers to a position of a defective die in the wafer, and the wafer image with labelled defect positions refers to a wafer image that labels the positions of defective die on the wafer. FIGS. 2 to 9 illustrate such wafer images, wherein the dark gray dots represent the positions of defect dies. As can be seen from FIGS. 2 to 9, each wafer image may have a different distribution of defect positions. It should be noted that the defect positions of the wafer shown in FIGS. 2 to 9 are merely examples and are not intended to limit the invention.

In step S120, obtaining feature data of the wafer images by extracting features from the wafer images with a convolutional neural network (CNN).

According to this embodiment of the present disclosure, the CNN may include a plurality of convolutional layers, each followed by a pooling layer. Each of the convolutional layers may include at least one convolution kernel. In each of the convolutional layers, the quantity and architecture of the convolution kernel(s) may depend on a desired level of accuracy in extraction of the feature data. According to this embodiment, the number of convolution kernel(s) in each convolutional layer is not particularly limited and may be, for example, one, two, or three, etc. According to this embodiment, each convolution kernel is not particularly limited in architecture and may be 2×2, 3×3, or the like. Each pooling layer is configured to compress the feature data extracted by the corresponding preceding convolutional layer, and its architecture may be determined based on desired compression performance. According to this embodiment, the pooling layers are not particularly limited in architecture, and may be 2×2, 3×3, or the like.

Step S120 will be further described below in conjunction with the CNN. The CNN may comprise a first convolutional layer, a first pooling layer, a second convolutional layer, and a second pooling layer. The first convolutional layer may include three first convolution kernels, the architecture of each of the first convolutional kernels may be 3×3, and the architecture of the first pooling layer may be 2×2. The second convolutional layer may include six second convolution kernels, the architecture of each of the second convolutional kernels is 3×3, and the architecture of the second pooling layer is 2×2.

First of all, each of the 3×3 first convolution kernels convolves the wafer images to obtain three first feature data, which are then compressed by the 2×2 first pooling layer into respective three second feature data. Subsequently, each of the 3×3 second convolution kernels convolves the respective second feature data to obtain third feature data. Since six 3×3 convolution kernels convolve one second feature data, 6 third feature data may be obtained. Thus, the total number of the third feature data is 18. Finally, the 18 third feature data are compressed by the 2×2 second pooling layer into respective 18 fourth feature data. Thus, the feature data of the wafer images are 18 fourth feature data.

In some embodiments of the present disclosure, the CNN may include a plurality of convolutional layers which are paired, and each pair is followed by a pooling layer. Each of the convolutional layers may include at least one convolution kernel. The quantity and the architecture of the convolution kernel(s) may depend on a desired level of accuracy in feature data extraction. According to the embodiments of the present disclosure, the number of convolution kernel(s) in each convolutional layer is not particularly limited, and may be, for example, one, two, three, etc. According to these embodiments, each convolution kernel is not particularly limited in architecture, and may be 2×2, 3×3, or the like. Each pooling layer is configured to compress feature data extracted by the corresponding preceding pair of convolutional layers, and its architecture may be determined based on desired compression performance. According to these embodiments, the pooling layers are not particularly limited in architecture, and may be 2×2, 3×3, or the like.

In one embodiment of the present disclosure, the CNN may include a first convolutional layer, a second convolutional layer, a first pooling layer, a third convolutional layer, a fourth convolutional layer, and a second pooling layer. The first convolutional layer may include at least one first convolution kernel, the second convolutional layer may include at least one second convolution kernel, the third convolutional layer may include at least one third convolution kernel, and the fourth convolutional layer may include at least one fourth convolution kernel. In this case, as shown in FIG. 10, obtaining the feature data for the wafer image by extracting features therefrom with the CNN may include the following steps.

In step S1010, obtaining the first feature data by extracting features from the wafer images using the at least one first convolution kernel. According to this embodiment of the present disclosure, the quantity and architecture of the first convolution kernel(s) may depend on a desired level of accuracy in feature data extraction. For example, the architecture of the first convolution kernel(s) may be, but not limited to, 3×3, 4×4, or the like, and the number of the first convolution kernel(s) may be, but not limited to, one, two, three, etc.

In step S1020, obtaining the second feature data by extracting features from the first feature data using the at least one second convolution kernel. According to this embodiment of the present disclosure, the number and architecture of the second convolution kernel(s) may depend on a desired level of accuracy in feature data extraction. This embodiment is not limited in any particular number and architecture of the second convolution kernel(s). For example, the architecture of the second convolution kernel(s) may be, but not limited to, 3×3, 4×4, or the like, and the number of the second convolution kernel(s) may be, but not limited to, one, two, three, etc.

In step S1030, obtaining the third feature data by performing a first pooling process on the second feature data. According to this embodiment of the present disclosure, the first pooling process on the second feature data may be performed by the first pooling layer. The architecture of the first pooling layer may be determined by desired compression performance and may be, but not limited to, 2×2, 3×3, or the like.

In step S1040, obtaining the fourth feature data by extracting features from the third feature data using the at least one third convolution kernel. According to this embodiment of the present disclosure, the number and architecture of the third convolution kernel(s) may depend on a desired level of accuracy in feature data extraction. This embodiment is not limited in any particular number and architecture of the third convolution kernel(s). For example, the architecture of the third convolution kernel(s) may be, but not limited to, 3×3, 4×4, or the like, and the number of the third convolution kernel(s) may be, but not limited to, one, two, three, etc.

In step S1050, obtaining the fifth feature data by extracting features from the fourth feature data using the at least one fourth convolution kernel. According to this embodiment of the present disclosure, the number and architecture of the fourth convolution kernel(s) may depend on a desired level of accuracy in feature extraction. This embodiment is not limited in any particular number and architecture of the fourth convolution kernel(s). For example, the architecture of the fourth convolution kernel(s) may be 3×3, 4×4, or the like, and the number of the fourth convolution kernel(s) may be one, two, three, etc., and this embodiment is not particularly limited in this regard.

In step S1060, obtaining the feature data of the wafer images by performing a second pooling process on the fifth feature data. According to this embodiment of the present disclosure, the second pooling process may be carried out by the second pooling layer. The architecture of the second pooling layer may be, for example, 2×2, 3×3, or the like, and this embodiment is not particularly limited in this regard.

Steps S1010-S1060 will be further described below in the context of 16 first convolution kernels, 16 second convolution kernels, a 2×2 first pooling layer, 32 third convolution kernels, 32 fourth convolution kernels, and a 2×2 second pooling layer. The architecture of each of the first convolution kernels is 3×3, the architecture of each of the second convolution kernels is 3×3, the architecture of each of the third convolution kernels is 3×3, and the architecture of each of the fourth convolution kernels is 3×3.

First of all, each of the 3×3 first convolution kernels convolves the wafer images, i.e., extracts features from the wafer images based on each of the 3×3 first convolution kernels, to obtain 16 first feature data. Next, each of the 3×3 second convolution kernels convolves the first feature data, i.e., extracts features from the first feature data based on each of the 3×3 second convolution kernels, to obtain second feature data. Since 16 3×3 second convolution kernels convolve one first feature data, 16 second feature data can be obtained. Thus, when 16 3×3 second convolution kernels convolves the first feature data respectively, the total number of the second feature data are 256. The 2×2 first pooling layer then performs a first pooling process on each of the second feature data, i.e., compressing each of the second feature data by the 2×2 first pooling layer, to obtain 256 third feature data. Then, each of the 3×3 third convolution kernels convolves the third feature data, i.e., extracts features from the third feature data based on each of the 3×3 third convolution kernels, to obtain fourth feature data. Since 32 3×3 third convolution kernels convolve one third feature data, 32 fourth feature data can be obtained. Thus, when 32 3×3 third convolution kernels convolves the third feature data respectively, the total number of the fourth feature data are 8,192. Subsequently, each of the 3×3 fourth convolution kernels convolves the fourth feature data, i.e., extracts features from the fourth feature data based on each of the 3×3 fourth convolution kernels, to obtain fifth feature data. Since 32 3×3 fourth convolution kernels convolve one fourth feature data, 32 fifth feature data can be obtained. Thus, when 32 3×3 second convolution kernels convolves fourth feature data respectively, the total number of the fifth feature data are 285,184. The 2×2 second pooling layer then performs a second pooling process on each of the fifth feature data, i.e., compressing each of the fifth feature data by the 2×2 second pooling layer, to obtain 285,184 sixth feature data. The 285,184 sixth feature data are the aforementioned feature data of the wafer images.

It should be noted that, compared to the architecture in which each convolutional layer is followed by a pooling layer, the architecture with a pooling layer following each convolutional layer pair allows the extraction of more features and thereby improving accuracy of the feature data of the wafer images.

In step S130, generating feature codes of the wafer images by encoding the feature data of the wafer images with an auto-encoder.

According to one embodiment of the present disclosure, the auto-encoder may include at least one encoding layer and at least one decoding layer. Each encoding layer may include a plurality of neurons, and the number of the neurons can be configured based on a desired encoding effect. Each decoding layer may include a plurality of neurons, and the number of the neurons can be configured based on a desired decoding effect.

Step S130 will be further described below in the context of the auto-encoder including two encoding layers and two decoding layers. The two encoding layers are a first encoding layer comprising 256 neurons and a second encoding layer comprising 128 neurons. The two decoding layers are a first decoding layer comprising 128 neurons and a second decoding layer comprising 256 neurons.

At first, the 256 neurons in the first encoding layer may perform a first encoding process on the feature data of the wafer images to obtain first feature codes. The 128 neurons in the second encoding layer then encode the first feature codes into second feature codes, i.e., the second feature codes are feature codes of the wafer images.

In step S140, clustering feature codes of the wafer images and performing defect pattern classification on the wafer images based on a result of the clustering.

According to one embodiment of the present disclosure, the feature codes for each of the wafer images may be obtained from the above-discussed steps S110-S130. The obtained feature codes may be clustered using a clustering algorithm, and defect pattern classification may be performed on the wafer images based on a result of the clustering. Suitable clustering algorithms may include k-means, density-based clustering, maximum likelihood estimation of Gaussian mixture model, and affinity propagation, etc., and this embodiment is not limited to any particular clustering algorithm.

For example, clustering the feature codes of the wafer images using an affinity propagation algorithm may include calculating a distance between the feature codes for any two of the wafer images. If the distance of the two wafer images is smaller than a predefined distance, the feature codes of the two wafer images are determined to be belonged to the same class. If the distance between the feature codes of the two wafer images is greater than or equal to the predefined distance, the feature codes of the two wafer images are determined to be belonged to different classes. It should be noted that the predefined distance may be defined by the developer. With clustering the feature codes of the plurality of wafer images by the affinity propagation algorithm, an automatic determination of the number of classes resulting from the clustering can be achieved. This eliminates the need to preset the number of classes beforehand and allows a higher classification accuracy.

Specifically, clustering the feature codes of the wafer images and performing defect pattern classification on the wafer images based on the result of the clustering may include determining at least one feature class by clustering the feature codes of the plurality of wafer images, and performing defect pattern classification on the wafer images based on the at least one feature class, wherein each feature class corresponds to one defect pattern.

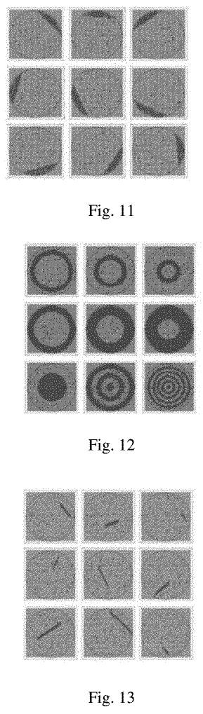

According to one embodiment of the present disclosure, the feature codes of the wafer images may be classified into at least one feature class based on the clustering. Each feature class may include feature data of at least one wafer image. Due to the correspondence of the wafer images with their feature data, based on the feature data to which the feature codes of the wafer images belong, the feature classes to which the wafer images belong can be known. Finally, defect patterns of the wafer images may be determined based on one-to-one correspondence between the feature classes and the defect patterns. As a result, defect pattern classification of the wafer images can be achieved. The defect pattern may include one or more of edge arche-like defect pattern, ring-like defect pattern, and strip-like defect pattern. FIGS. 11-13 describes these three defect patterns, in which, FIG. 11 shows nine wafer images with edge arch-like defects pattern, FIG. 12 shows nine wafer images with ring-like defect pattern, and FIG. 13 shows nine wafer images with strip-like defect pattern.

It should be noted that the defect patterns shown in FIGS. 11-13 are merely exemplary and not intended to limit the present invention, and the one-to-one correspondence between the defect patterns and the feature classes may be configured in advance. As such, with the determined feature classes, the defect patterns of the wafer images respectively belonging to these feature classes can be confirmed based on the one-to-one correspondence between the feature classes and defect patterns.

The above process will be further described. For example, assuming there are 10 wafer images having 10 respective feature codes clustered and classified into three feature classes. The three feature classes may include a first feature class, to which the feature codes of the first, third, and fourth wafer images belong, a second feature class, to which the feature codes of the second, fifth, eighth, and tenth wafer images belong, and a third feature class, to which the feature codes of the sixth, seventh, and ninth wafer images belong. From above description, it can be known that the first, third, and fourth wafer images belong to the first feature class, the second, fifth, eighth, and tenth wafer images belong to the second feature class, and the sixth, seventh, and ninth wafer images belong to the third feature class. If the first feature class corresponds to an edge arch-like defect pattern, the second feature class to a ring-like defects pattern, and the third feature class to a strip-like defect pattern, it can be known that, among the 10 wafer images, the first, third, and fourth wafer images have the edge arch-like defects pattern, the second, fifth, eighth, and tenth wafer images have the ring-like defect pattern, and the sixth, seventh, and ninth wafer images have the strip-like defect pattern.

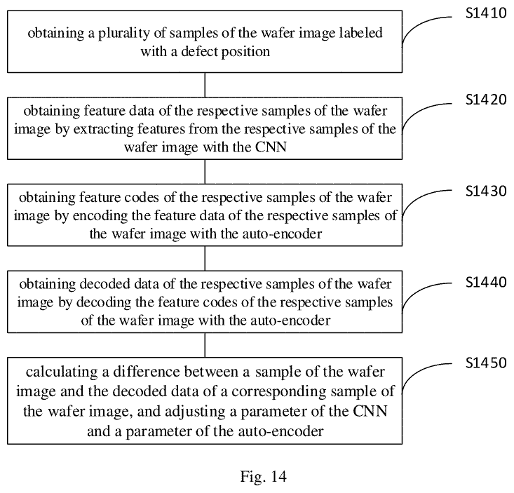

Further, as shown in FIG. 14, prior to acquiring the wafer images labeling a defect position, the method may further include the following steps.

In step S1410, obtaining samples of the wafer image labeled with defect positions.

According to one embodiment of the present disclosure, the samples of the wafer image labeled with defect positions may be obtained either directly from the EDA system or from the acquisition module. Since the samples of the wafer image are similar to the above-described wafer images, a further description thereof is omitted.

In step S1420, obtaining feature data of the samples of the wafer image by extracting features from the samples of the wafer image using a CNN.

According to one embodiment of the present disclosure, parameters of the CNN may either be set by the developer based on his/her own experience, or by initializing the CNN parameters. This embodiment is not particularly limited in this regard. The CNN parameters may include the numbers of convolutional layers, the numbers of pooling layers, and the numbers of convolution kernels in each convolutional layer, as well as the architectures of the convolution kernels and the architectures of the pooling layers.

Since the CNN extracts features and obtains feature data from the samples of the wafer image in the same way as it extracts features and obtains feature data from the wafer images in step S120, the description of this process of obtaining feature data of the samples of the wafer image by extracting features from the samples of the wafer image using a CNN is omitted.

It should be noted that the CNN parameters for step S1420 may differ from those for step S120.

In step S1430, obtaining feature codes of the samples of the wafer image by encoding the feature data thereof with the auto-encoder.

According to one embodiment of the present disclosure, the developer can set parameters for the auto-encoder based on his/her experience. The parameters of the auto-encoder may include the numbers of encoding layers, the numbers of decoding layers, the numbers of neurons in each encoding layer, and the numbers of neurons in each decoding layer, etc.

The process to obtain the feature codes of the samples of the wafer image by encoding the feature data thereof using the auto-encoder which includes three encoding layers, as an example, will be described in detail below. The first encoding layer in the auto-encoder may encode the feature data of the samples of the wafer image to obtain first feature codes. Second feature codes are then obtained by encoding the first feature codes with the second encoding layer. Third feature codes are then obtained by encoding the second feature codes with the third encoding layer. The third feature codes are feature codes of the samples of the wafer image.

It should be noted that the auto-encoder encodes the feature data and obtains feature codes of the samples of the wafer image in the same way as it does in step S130, except that different sets of parameters are used.

In step S1440, obtaining decoded data of the samples of the wafer image by decoding the feature codes thereof using the auto-encoder.

Since the auto-encoder has been described above in step S1430, a further description thereof is omitted. The process to obtain the decoded data of the samples of the wafer image by decoding the feature codes thereof using the auto-encoder which includes three decoding layers, as an example, will be described in detail below. The first decoding layer decodes the feature codes of the samples of the wafer image to obtain first decoded data, which are then decoded by the second decoding layer into second decoded data. Finally, the third decoding layer decodes the second decoded data into third decoded data. The third decoded data are decoded data of the samples of the wafer image.

It should be noted that the auto-encoder decodes the feature codes of the samples of the wafer image and obtains their decoded data in the same way as it does in step S130, except that different sets of parameters are used.

In step S1450, a difference between the samples of the wafer image and their decoded data is calculated, and parameters of the CNN and auto-encoder are adjusted accordingly.

According to one embodiment of the present disclosure, the difference between the samples of the wafer image and their decoded data may be calculated by pixel values in the samples of the wafer image and corresponding dimension values in the decoded data of the samples of the wafer image. Specifically, pixel dimensions of the samples of the wafer image and data dimensions of the decoded data of the samples of the wafer image may be obtained to determine whether there is consistency between pixel dimensions of the samples of the wafer image and data dimensions of the wafer image samples. If so, the pixel values of the samples of the wafer image and corresponding dimension values of the samples of the wafer image may be obtained, and the difference between the samples of the wafer image and decoded data of the corresponding samples of the wafer image can be calculated according to

$${S}_{j} = \frac{{\sum }_{i = 1}^{N} {X}_{i , j} - {Y}_{i , j}}{{A}_{j}} ,$$

where, Sⱼ represents the difference between the j-th sample of the wafer image and its decoded data, Aⱼ is the pixel or data dimension of the j-th sample of the wafer image, X_{i,j} is the pixel value of the i-th dimension in the j-th sample of the wafer image, and is the data value of the i-th dimension in the decoded data of the j-th sample of the wafer image.

If the difference between the samples of the wafer image and their decoded data is greater than a predefined difference, the parameters of the CNN and auto-encoder can be adjusted to increase their accuracy.

The CNN and auto-encoder can be trained with the process comprising steps S1410-S1450 to obtain the CNN in step S120 and the auto-encoder in step S130.

In summary, an automatic defect pattern classification on wafer images achieved by a combination of the CNN, automatic encoding, and clustering techniques can significantly reduce the amount and cost of labor and enhance classification efficiency, when compared to the conventional manual classification methods. In addition, because of elimination of the manual classification, human errors can be avoided, resulting in a much higher classification accuracy. Moreover, due to the automatic classification, the method is suitable for use with an EDA system, which can impart more power in processing massive data. Furthermore, compared to a supervised classification approach merely using the CNN for classification and requiring more time for feature extraction, the combination of CNN, automatic encoding, and clustering is an unsupervised approach to obtain classification results simply by inputting wafer images with labeled defect positions, without consuming considerable time in feature acquisition. As a result, the time required by the entire classification process can be remarkably shortened, thereby improving classification efficiency.

It is to be noted that while the steps in the method of the present disclosure are illustrated in a particular order in the accompanying drawings, this is not intended to require or imply that the steps must be performed in the order presented, or that the desired benefits can only be achieved when all the steps are performed. Additionally or alternatively, one or more of the steps can be omitted, and/or some of them can be combined into a single step, and/or a certain step can be divided into multiple steps.

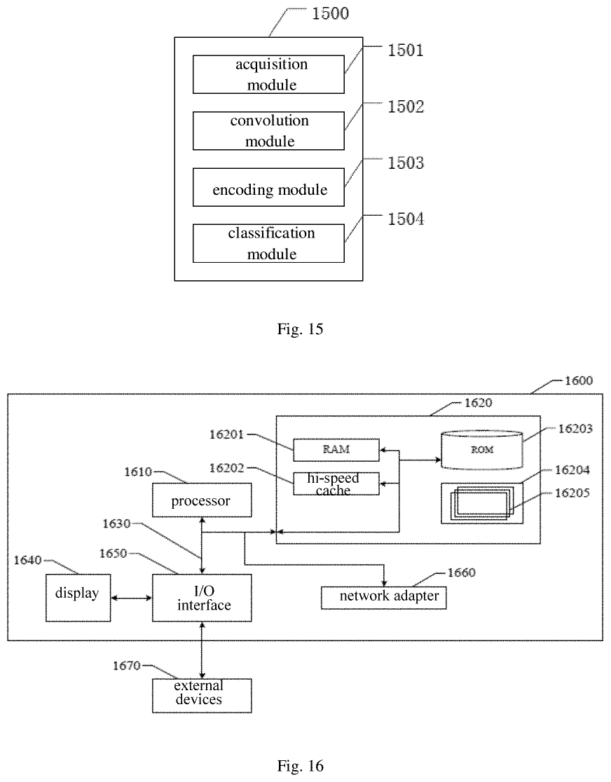

In an embodiment of the present disclosure, there is also provided an apparatus for classification of wafer defect patterns. As shown in FIG. 15, the apparatus 1500 may include an acquisition module 1501, a convolution module 1502, an encoding module 1503, and a classification module 1504.

The acquisition module 1501 may be configured to obtain wafer images with labeled defect positions.

The convolution module 1502 may be configured to obtain feature data of the wafer image by extracting features from the wafer image using a CNN.

The encoding module 1503 may be configured to generate feature codes of the wafer images by encoding the feature data of the wafer images using an auto-encoder.

The classification module 1504 may be configured to cluster the feature codes of the wafer images and perform defect pattern classification of the wafer images based on a result of the clustering.

Since the features of the various modules in the apparatus are the same as those of the corresponding steps in the above-discussed method, a further description of the various modules is omitted here.

It should be noted that although several modules or units of devices for taking actions are mentioned in the detailed description above, such division is not mandatory. Indeed, in accordance with embodiments of the present disclosure, the features and functions of two or more modules or units described above may be embodied in one module or unit. Conversely, the features and functions of one of the modules or units described above may be further divided into multiple modules or units.

In embodiments of the present disclosure, there is also provided an electronic device suitable for implementing the method as defined above.

As be appreciated by one skilled in the art, aspects of the present invention may be embodied as a system, method, or program product. Accordingly, aspects of the present invention may take the form of an entirely hardware embodiment, an entirely software embodiment (including firmware, micro-code, etc.,) or an embodiment combining software and hardware aspects that may all generally be referred to herein as a “circuit,” “module,” or “system”.

An electronic device 1600 according to embodiments of the present invention will be described below with reference to FIG. 16. The electronic device 1600 is only one example and is not intended to suggest any limitation to the scope of use or functionality of embodiments of the invention described herein.

As shown in FIG. 16, the electronic device 1600 may be implemented as a general-purpose computing device. The components of the electronic device 1600 may include, but are not limited to, one or more processors 1610, at least one memory 1620, a bus 1630 coupled with various system components (including the memory 1620 and the processors 1610,) and a display 1640.

The memory 1620 may store program codes that can be executed by the processors 1610 to cause the processors 1610 to execute the steps according to the various embodiments described above. For example, the processors 1610 may execute, as shown in FIG. 1, step S110 to obtain wafer images with labeled defect positions, step S120 to obtain feature data of the wafer image by extracting features therefrom with a CNN, step S130 to generate feature codes of the wafer images by encoding the feature data thereof using an auto-encoder, and step S140 to cluster the feature codes of the plurality of wafer images and perform defect pattern classification on the respective wafer images based on a result of the clustering.

The memory 1620 may include a readable medium in the form of a volatile memory, such as a random-access memory (RAM) 16201 and/or a high-speed cache memory 16202, as well as a read only memory (ROM) 16203.

The memory 1620 may further include a program/utility 16204 having a set (at least one) of program modules 16205. Such program modules 16205 may include, but are not limited to, an operating system, one or more application programs, other program modules and program data. Each of the operating system, one or more application programs, other program modules, and program data, or some combination thereof, may include an implementation of a networking environment.

The bus 1630 may represent one or more of several types of bus structures, including a memory bus or memory controller, a peripheral bus, an accelerated graphics port, and a process unit or local bus using any of a variety of bus architectures.

The electronic device 1600 may also communicate with one or more external devices 1670 (e.g., a keyboard, a pointing device, or a Bluetooth device, etc.), one or more devices that enable a user to interact with the electronic device 1600 and/or any devices (e.g., router, modem, etc.) that enable the electronic device 1600 to communicate with one or more other general-purpose computing devices. Such communication can be conducted via input/output (I/O) interfaces 1650. Further, the electronic device 1600 may communicate with one or more networks (e.g., a local area network (LAN), a general wide area network (WAN), and/or a public network such as the Internet) via a network adapter 1660. As depicted, the network adapter 1660 may communicate with the other components of the electronic device 1600 via the bus 1630. It should be understood that, although not shown in figures, other hardware and/or software components could be used in conjunction with the electronic device 1600. For example, other hardware and/or software components may comprise, but are not limited to, microcode, device drivers, redundant processing units, external disk drive arrays, RAID systems, tape drives, and data archival storage systems, etc.

From the description of the above embodiments, those skilled in the art may understand that, the embodiment disclosed herein may be implemented either by software or by a combination of software and necessary hardware. Therefore, the embodiments of the present invention can be embodied in a software product which may be stored in a non-volatile storage medium (e.g., a CD-ROM, USB flash drive, portable hard drive, etc.) or in a network, and may include a number of instructions for causing a computing device (e.g., a PC, server, terminal device, network device, etc.) to implement the method disclosed in the embodiments of the present invention.

In an embodiment of the present disclosure, there is also provided a computer-readable storage medium storing a program product suitable of implementing the method disclosed above. In some embodiments, various aspects of the present invention may also be implemented in the form of a program product including program codes for causing a terminal device, on which the program product runs, to execute the steps of embodiments described above.

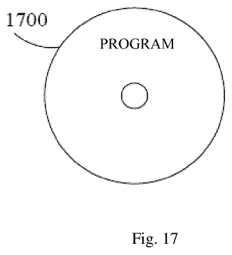

FIG. 17 illustrates a program product 1700 for implementing the method described in embodiments of the present invention. The program product 1700 may be a portable compact disk read only memory (CD-ROM) containing program codes that can be run on a terminal device such a personal computer (PC). However, the program product of the present invention is not limited thereto. The readable storage medium herein may be any tangible medium that can contain or store a program for use by or in connection with an instruction execution system, apparatus, or device.

The program product may be implemented as any combination of one or more readable media, each in the form of a readable signal medium or a readable storage medium. The readable storage medium may be, for example, but is not limited to, an electronic, magnetic, optical, electromagnetic, infrared, or semiconductor system, apparatus, or device, or any suitable combination thereof. More examples of the readable storage medium would include an electrical connection having one or more wires, a portable computer diskette, a hard disk, a random access memory (RAM), a read-only memory (ROM), an erasable programmable read-only memory (EPROM or Flash memory), an optical fiber, a CD-ROM, an optical storage device, a magnetic storage device, or any suitable combination thereof.

The computer-readable signal medium may include a propagated data signal with computer readable program codes embodied therein, for example, in baseband or as part of a carrier wave. Such a propagated signal may be in a variety of forms, including, but not limited to, electro-magnetic, optical, or any suitable combination thereof. The readable signal medium may also be any readable medium that is not a readable storage medium. The readable medium can communicate, propagate, or transport a program for use by or in connection with an instruction execution system, apparatus, or device.

Program codes embodied on the computer readable medium may be transmitted using any appropriate medium including, but not limited to, wireless, wireline, optical fiber cable, RF, etc., or any suitable combination thereof.

Program codes for executing operations of the present invention may be written in any combination of one or more programming languages, including an object-oriented programming language such as Java, C++ or the like, and conventional procedural programming languages, such as the “C” programming language or similar programming languages. The program codes may execute entirely on the user's computer, partly on the user's computer, as a stand-alone software package, partly on the user's computer and partly on a remote computer, or entirely on a remote computing device or server. In the latter scenario, the remote computing device may be connected to the user's computer through any type of network, including a local area network (LAN) or a wide area network (WAN), or the connection may be made to an external computing device, for example, through the Internet provided by an Internet Service Provider.

Further, the figures are merely illustrations of a series of processes included in the method according to embodiments of the present invention and are not intended to limit the present invention. It is to be understood that the processes illustrated in figures do not indicate any chronological order of the processes or limit them to a particular chronological order. Furthermore, it is also to be understood that the processes may be performed, for example, synchronously or asynchronously in multiple modules.

Other embodiments of the present disclosure will be obvious to those skilled in the art according to the specification and the invention disclosed herein. Accordingly, this disclosure is intended to cover all and any variations, uses, or adaptations of the disclosure which follow, in general, the principles thereof and include such departures from the present disclosure as come within common knowledge or customary practice within the art to which the invention pertains. It is also intended that the specification and examples be considered as exemplary only, with true scope and spirit of the disclosure being indicated by the appended claims.

It is to be understood that the present disclosure is not limited to the exact structures as described above and illustrated in the figures and may be modified or changed without departing from its scope. The scope of the disclosure is intended to be defined only by the appended claims.

What is claimed is:

1. A method for classification of wafer defect patterns, comprising:
obtaining a trained convolutional neural network (CNN) and a trained auto-encoder;
acquiring a wafer image with at least a labelled defect position;
obtaining a feature datum of the wafer image by extracting a feature from the wafer image with the trained CNN;
generating a feature code of the wafer image by encoding the feature datum of the wafer image with the trained auto-encoder; and
clustering feature codes of a plurality of wafer images with at least a labelled defect position, and performing the defect pattern classification on the respective wafer images based on a result of the clustering.

2. The method of claim 1, wherein the obtaining the feature datum of the wafer image by extracting the feature from the wafer image with the trained CNN comprises:
obtaining a first feature datum by extracting the feature from the wafer image with at least one first convolution kernel;
obtaining a second feature datum by extracting a feature from the first feature datum with at least one second convolution kernel;
obtaining a third feature datum by performing a first pooling process on the second feature datum;
obtaining a fourth feature datum by extracting a feature from the third feature datum with at least one third convolution kernel;
obtaining a fifth feature datum by extracting a feature from the fourth feature datum with at least one fourth convolution kernel; and
obtaining the feature datum of the wafer image by performing a second pooling process on the fifth feature datum.

3. The method of claim 1, wherein obtaining the trained CNN and the trained auto-encoder comprises:
obtaining an initial CNN and an initial auto-encoder;
obtaining a plurality of samples of the wafer image labeled with a defect position;
obtaining feature data of the respective samples of the wafer image by extracting features from the respective samples of the wafer image with the initial CNN;
obtaining feature codes of the respective samples of the wafer image by encoding the feature data of the respective samples of the wafer image with the initial auto-encoder;
obtaining decoded data of the respective samples of the wafer image by decoding the feature codes of the respective samples of the wafer image with the initial auto-encoder; and
calculating a difference between a sample of the wafer image and the decoded data of a corresponding sample of the wafer image, and adjusting at least a parameter of the initial CNN and at least a parameter of the initial auto-encoder to obtain the trained CNN and the trained auto-encoder.

4. The method of claim 3, wherein the calculating the difference between the sample of the wafer image and the decoded data of the corresponding sample of the wafer image comprises:
calculating the difference between the sample of the wafer image and the decoded data of the corresponding sample of the wafer image based on pixel values in the samples of the wafer image and corresponding dimension values in the decoded data of the samples of the wafer image.

5. The method of claim 1, wherein the clustering the feature codes of the plurality of wafer images and performing the defect pattern classification on the respective wafer images based on the result of the clustering comprises:
obtaining at least one feature class by clustering the feature codes of the plurality of wafer images; and
performing the defect pattern classification on the respective wafer images based on the at least one feature class, wherein each feature class corresponds to a respective one of the defect patterns.

6. The method of claim 1, wherein the clustering the feature codes of the plurality of wafer images comprises:
clustering the feature codes of the plurality of wafer images by using an affinity propagation algorithm.

7. The method of claims 1, wherein the defect pattern includes one or more of an edge arche-like defect pattern, a ring-like defect pattern, and a strip-like defect pattern.

8. The method of claim 1, wherein the trained CNN includes convolutional layers and pooling layers, wherein each of the convolutional layers is followed by one of the pooling layers.

9. The method of claim 8, wherein the convolutional layers are paired, and each pair of the convolutional layers is followed by one of the pooling layers.

10. The method of claim 1, wherein the trained auto-encoder comprises at least one encoding layer, each of the at least one encoding layer having a plurality of neurons, and at least one decoding layer, each of the at least one decoding layer having a plurality of neurons.

11. The method of claim 1, wherein the wafer image is acquired by an engineering data analysis (EDA) system.

12. An apparatus for classification of wafer defect patterns, comprising:
an acquisition module, configured to obtain a wafer image labeling a defect position;
a convolution module, configured to obtain a trained convolutional neural network (CNN) and obtain a feature datum of the wafer image by extracting a feature from the wafer image with the trained CNN;
an encoding module, configured to obtain a trained auto-encoder and generate a feature code of the wafer image by encoding the feature datum of the wafer image with the trained auto-encoder; and
a classification module, configured to cluster the feature codes of a plurality of wafer images and perform the defect pattern classification on the respective wafer images based on a result of the clustering.

13. A non-transitory computer-readable storage medium storing a computer program executable by a processor to cause the processor to perform operations comprising:
obtaining a trained convolutional neural network (CNN) and a trained auto-encoder;
acquiring a wafer image labeling a defect position;
obtaining a feature datum of the wafer image by extracting a feature from the wafer image with the trained CNN;
generating a feature code of the wafer image by encoding the feature datum of the wafer image with the trained auto-encoder; and
clustering feature codes of a plurality of wafer images and performing the defect pattern classification on the respective wafer images based on a result of the clustering.

14. An electronic device, comprising:
a processor; and
a memory device for storing an instruction executable by the processor,
wherein the processor is configured to execute the executable instruction to cause the processor to perform operations including:
obtaining a trained convolutional neural network (CNN) and a trained auto-encoder;
acquiring a wafer image labeling a defect position;
obtaining a feature datum of the wafer image by extracting a feature from the wafer image with the trained CNN;
generating a feature code of the wafer image by encoding the feature datum of the wafer image with the trained auto-encoder; and
clustering feature codes of a plurality of wafer images and performing the defect pattern classification on the respective wafer images based on a result of the clustering.
